(19) United States
(12) Patent Application Publication
(10) Pub. No.: US 2025/0365842 A1
(43) Pub. Date: Nov. 27, 2025

(54) CONTROL AND COMMISSIONING DEVICES FOR VERIFICATION OF A COMMISSIONED LIGHTING SYSTEM, AND SYSTEM COMPRISING SAID DEVICES

(71) Applicant: Tridonic Portugal, Unipessoal LDA, Villa Nova de Gaia (PT)

(72) Inventors: Kari Severinkangas, Villa Nova de Gaia (PT); Carlos Silva, Paredes (PT); Jorge Filipe, Porto (PT); Antonio Sousa, Valbom Gondomar (PT); João Azevedo, Braga (PT)

(73) Assignee: Tridonic Portugal, Unipessoal LDA, Villa Nova de Gaia (PT)

(21) Appl. No.: 18/872,111

(22) PCT Filed: Jun. 15, 2023
(86) PCT No.: PCT/EP2023/066061

§ 371 Date: Dec. 5, 2024

(30) Foreign Application Priority Data
Jul. 6, 2022 (EP) 22183210.8

(51) Int. Cl. H05B 47/175

(52) U.S. Cl. CPC H05B 47/199

(57) ABSTRACT

Disclosed is a control device (11) for verification of a commissioned lighting system (2). The control device (11) is configured to define (111) a verification path in a digital floor plan. The digital floor plan identifies and locates a respective component of a plurality of components (21) of the lighting system (2), and the verification path defines a verification sequence of the plurality of components (21). The control device (11) is further configured to receive (112) a start indication from a commissioning device (12); communicate (113) an actuation of a respective next component of the plurality of components (21) in accordance with the verification sequence; send (114) an actuation indication indicating the respective next component; receive (115) an actuation confirmation indicating an actuated component of the plurality of components (21); and verify (116) a match of the actuated component and the respective next component. This may avoid undue manual work and reduce a lighting system configuration time.

### CROSS REFERENCE TO RELATED APPLICATIONS

The present application is the U.S. national stage application of international application PCT/EP2023/066061 filed Jun. 15, 2023, which international application was published on Jan. 11, 2024 as International Publication WO 2024/008409 A1. The international application claims priority to European Patent Application No. 22183210.8 filed Jul. 6, 2022.

### TECHNICAL FIELD OF THE INVENTION

The present disclosure relates to lighting systems, and in particular, to a control device and a commissioning device for verification of a commissioned lighting system, and to a system comprising a control device and a commissioning device.

### BACKGROUND OF THE INVENTION

In modern lighting systems, system components such as luminaires are part of a lighting network, wherein each component is reachable from a central device at least during a commissioning process.

The commissioning process requires authenticating, identifying and localizing the components, so that they can be remotely controlled.

A final step in installation of a lighting system is to verify that all system components work according to plan and that they have been correctly identified and localized. Usually, this step

is manual. A user navigates through the installation, presses controls provided by a software application and checks if system components such as luminaires respond as they should. When errors occur, they are manually corrected.

### SUMMARY OF THE INVENTION

In view of the above-mentioned drawbacks and limitations, the present disclosure aims to improve a verification of commissioned lighting systems. An objective is to automate a verification process to thereby reduce manual work and a lighting system configuration time.

The objective is achieved by the embodiments as defined by the appended independent claims. Preferred embodiments are set forth in the dependent claims and in the following description and drawings.

A first aspect of the present disclosure relates to a control device for verification of a commissioned lighting system. The control device is configured to define a verification path in a digital floor plan. The digital floor plan identifies and locates a respective component of a plurality of components of the lighting system, and the verification path defines a verification sequence of the plurality of components. The control device is further configured to receive a start indication from a commissioning device; communicate an actuation of a respective next component of the plurality of components in accordance with the verification sequence; send an actuation indication indicating the respective next component; receive an actuation confirmation indicating an actuated component of the plurality of components; and verify a match of the actuated component and the respective next component.

For defining the verification path, the control device may further be configured to define the verification path in accordance with an algorithm of combinatorial optimization.

The algorithm may implement a travelling salesperson problem.

For defining the verification path, the control device may further be configured to receive an appendage indication from the commissioning device; and append the appendage component to the verification path. The appendage indication indicates an appendage component of the plurality of components.

The respective next component may comprise a sensor or light switch; and the actuation may comprise an actuation of the respective next component by a user. For communicating the actuation, the control device may further be configured to detect the actuation of the respective next component.

The respective next component may comprise a luminaire; and the actuation may comprise an actuation of the respective next component by the control device. For communicating the actuation, the control device may further be configured to perform the actuation of the respective next component.

The respective next component may comprise a group of components of the plurality of components.

For verifying the match, the control device may further be configured to readdress the respective next component responsive to a mismatch of the actuated component and the respective next component.

A second aspect of the present disclosure relates to commissioning device for verification of a commissioned lighting system. The commissioning device comprises a user interface and is configured to display a verification path in a digital floor plan. The digital floor plan identifies and locates a respective component of a plurality of components of the lighting system, and the verification path defines a verification sequence of the plurality of components. The commissioning device is further configured to send a start indication to a control device for verification of the commissioned lighting system responsive to a touch of a symbol in the user interface representing a start button; receive an actuation indication indicating a respective next component of the plurality of components in accordance with the verification sequence from the control device; highlight a symbol in the user interface representing the respective next component; detect a touch of a symbol in the user interface representing an actuated component of the plurality of components as determined by the user; and send an actuation confirmation indicating the actuated component to the control device.

The commissioning device may further be configured to send a start indication to the control device responsive to a touch of a symbol in the user interface representing a start button of an automatic operation mode; and detect, in the automatic operation mode, a lapse of a configurable timeout timer following which the the respective next component represented by the highlighted symbol is taken as the actuated component.

The commissioning device may further be configured to define the verification path.

For defining the verification path, the commissioning device may further be configured to send an appendage indication to the control device responsive to a touch of a symbol in the user interface representing an appendage component of the plurality of components for appending to the verification path, the appendage indication indicating the appendage component.

A third aspect of the present disclosure relates to a system for verification of a commissioned lighting system. The system comprises a control device according to the first aspect or any of its implementations; a commissioning device according to the second aspect or any of its implementations; and communication means for connecting the control device, the commissioning device and a plurality of components of the lighting system.

### Advantageous Effects

The verification process can be automated in modern lighting systems where luminaires are linked to a digital floor plan.

The present disclosure provides a verification process being guided by a control device in accordance with a verification path in the digital floor plan and being assisted by a user-operated commissioning device. Typically, no manual correction is needed. The verification process is automated, thereby reducing manual work and a lighting system configuration time.

The technical effects and advantages described above equally apply to the control device, the commissioning device, and the system comprising said devices.

### BRIEF DESCRIPTION OF THE DRAWINGS

The above-described aspects and implementations will now be explained with reference to the accompanying drawings, in which the same or similar reference numerals designate the same or similar elements.

The features of these aspects and implementations may be combined with each other unless specifically stated otherwise.

The drawings are to be regarded as being schematic representations, and elements illustrated in the drawings are not necessarily shown to scale. Rather, the various elements are represented such that their function and general purpose become apparent to those skilled in the art.

FIG. 1 illustrates schematically a system 1 in accordance with the present disclosure for verification of a commissioned lighting system 2;

FIG. 2 illustrates schematically a control device 11 in accordance with the present disclosure, and its workflow for verification of a commissioned lighting system 2;

FIG. 3 illustrates schematically a commissioning device 12 in accordance with the present disclosure, and its workflow for verification of a commissioned lighting system 2;

FIG. 4 illustrates the interlinked workflows of FIGS. 2 and 3 when verifying sensors or light switches of a commissioned lighting system 2;

FIG. 5 illustrates the interlinked workflows of FIGS. 2 and 3 when verifying luminaires of a commissioned lighting system 2;

FIG. 6 illustrates a digital floor plan comprising a plurality of components 21 of a commissioned lighting system 2; and

FIG. 7 illustrates an exemplary verification path in the digital floor plan of FIG. 6.

### DETAILED DESCRIPTION OF THE EXEMPLARY EMBODIMENT

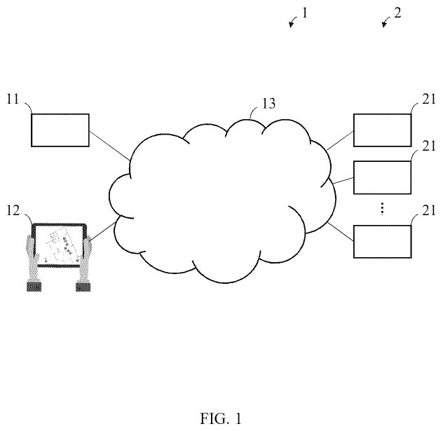

FIG. 1 illustrates schematically a system 1 in accordance with the present disclosure for verification of a commissioned lighting system 2.

As used herein, verification may relate to a process taking place after a lighting system 2 has been commissioned, including addressing and localizing each of a plurality of components 21 of the lighting system 2 in the installation.

The lighting system 2 comprises a plurality of components 21 shown on the right of FIG. 1.

As shown on the left of FIG. 1, the system 1 comprises a control device 11 according to the first aspect or any of its implementations.

As used herein, a control device may relate to a computing platform involving hardware and/or software components and being configured to control the lighting system 2. For example, the control device may activate or deactivate output components of the lighting system 2 such as luminaires, blind/shutter drives etc. responsive to stimulus received from input components of the lighting system 2 such as daylight sensors, motion sensors, light switches and so on.

The control device 11 is configured to host a digital floor plan of a building and configuration information of the plurality of components 21 of the lighting system 2. Each of the plurality of components 21 is linked to the digital floor plan, and a user may control the plurality of components 21, such as luminaires, in groups or individually.

The control device 11 may comprise a cloud server.

As used herein, a cloud server may relate to a computing platform being hosted remotely from the lighting system 2 in a private or public computing cloud, such as a data center.

Alternatively, the control device 11 may comprise a network edge device.

As used herein, a network edge device may relate to a computing platform being hosted at a boundary (“network edge”) of a network context of the lighting system 2 (think of addressing). The network edge device may thus serve as a gateway between the lighting system 2 and other network contexts, such as Internet Protocol (IP) networking, for example.

As shown on the left of FIG. 1, the system 1 further comprises a commissioning device 12 according to the second aspect or any of its implementations.

As used herein, a commissioning device may relate to a computing platform involving hardware and/or software components, typically a user-operated handheld device, and being configured to serve as a user interface of the lighting system 2 in general and of its control device 21 in particular. For example, the commissioning device may comprise a touch-sensitive screen (“touchscreen”) for user input/output.

The commissioning device 12 may comprise the control device 11.

When integrated into the commissioning device 12, all required functions of the control device 11 would be provided by the commissioning device 12 without any cloud interaction, and the commissioning device 12 would send out control commands to the luminaires, receive signals from sensors etc.

As shown in the middle of FIG. 1, the system 1 further comprises communication means 13 for connecting the control device 11, the commissioning device 12 and the plurality of components 21 of the lighting system 2.

The communication means 13 may comprise one or more of: a radio network, a line-bound network, and a lighting control network. For example, the radio network may comprise a Bluetooth Low Energy (BLE) radio network, a Z-Wave radio network, a Zigbee radio network, an IEEE 802.11 (Wi-Fi) radio network, and/or an IEEE 802.15.4-based radio network (e.g., Thread). For example, the line-bound network may comprise an IEEE 802.3 (Ethernet/LAN) network, and/or a Digital Addressable Lighting Interface (DALI, DALI-2, D4i) lighting control network.

As such, the plurality of components 21 of the lighting system 2 enjoy network connectivity to the control device 11.

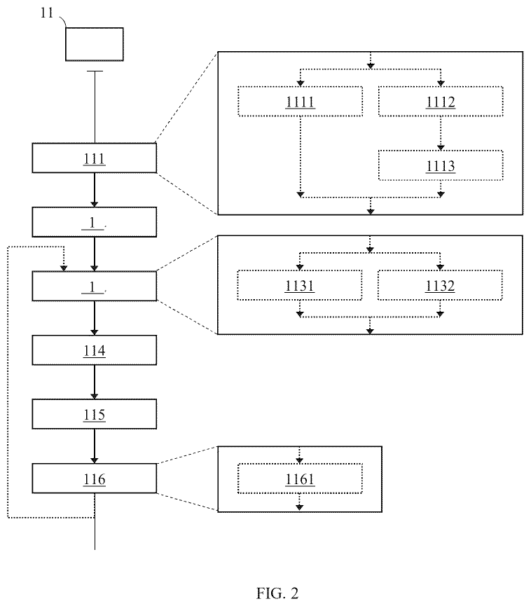

FIG. 2 illustrates schematically a control device 11 in accordance with the present disclosure, and its workflow for verification of a commissioned lighting system 2.

The control device 11 may comprise a processing unit (not shown) such as a Central Processing Unit (CPU) being configured to perform a method implementing the workflow.

The control device 11 is configured to define 111 a verification path in a digital floor plan.

As used herein, a verification path may refer to a movement curve/trajectory of a user in a digital floor plan according to which a verification process is to be carried out.

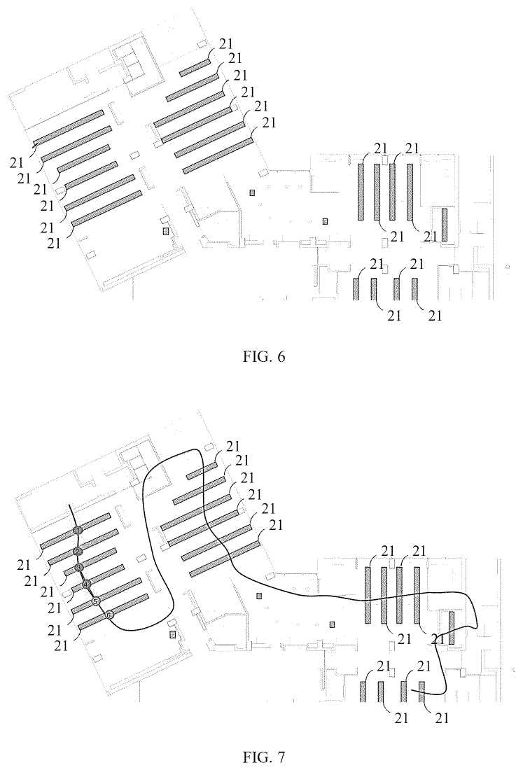

The digital floor plan identifies and locates a respective component of a plurality of components 21 of the lighting system 2 (see FIG. 6), and the verification path defines a corresponding verification sequence (e.g., 1, 2, 3, 4, 5, 6, . . . ) of the plurality of components 21 (see FIG. 7).

As used herein, a verification sequence may refer to an order/sequence/succession of components of a lighting system according to which a verification process is to be carried out.

For defining 111 the verification path, the control device 11 may further be configured to define 1111 the verification path in accordance with an algorithm of combinatorial optimization.

In particular, the algorithm may implement a travelling salesperson problem providing an exact or approximate solution.

Alternatively, for defining 111 the verification path, the control device 11 may further be configured to receive 1112 an appendage indication from the commissioning device 12. The appendage indication may indicate an appendage component of the plurality of components 21. The control device 11 may further be configured to append 1113 the appendage component to the verification path.

In other words, one component 21 after the other of the plurality of components 21 of the lighting system 2 may be appended to the verification path in accordance with corresponding user inputs via the commissioning device 12.

That is to say, the user may define a path in the digital floor plan, the path representing an order according to which luminaires and other components 21 of the lighting system 2 should be verified.

The control device 11 is further configured to receive 112 a start indication from the commissioning device 12.

The control device 11 is further configured to communicate 113 an actuation of a respective next component of the plurality of components 21 in accordance with the verification sequence.

The respective next component may comprise a sensor, a light switch, or any other input component; and the actuation may comprise an actuation of the respective next component by a user. For communicating 113 the actuation, the control device 11 may further be configured to detect 1131 the actuation of the respective next component.

Alternatively, the respective next component may comprise a luminaire or any other output component; and the actuation may comprise an actuation of the respective next component by the control device 11. For communicating 113 the actuation, the control device 11 may further be configured to perform 1132 the actuation of the respective next component.

The respective next component may even comprise a group of components of the plurality of components 21. For example, the respective next component may be identified by a group address, a group address prefix, or sequential or concurrent individual addressing of the components of a group.

The control device 11 is further configured to send 114 an actuation indication indicating a respective next component.

The control device 11 is further configured to receive 115 an actuation confirmation indicating an actuated component of the plurality of components 21.

The control device 11 is further configured to verify 116 a match of the actuated component and the respective next component.

For verifying 116 the match, the control device 11 may further be configured to readdress 1161 the respective next component responsive to a mismatch of the actuated component and the respective next component.

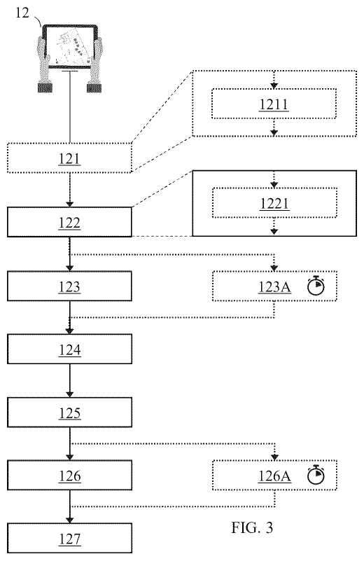

FIG. 3 illustrates schematically a commissioning device 12 in accordance with the present disclosure, and its workflow for verification of a commissioned lighting system 2.

The commissioning device 12 may comprise a processing unit (not shown) such as a CPU being configured to perform a method implementing the workflow.

The commissioning device 12 comprises a user interface, such as a touch-sensitive screen, for user input/output.

The commissioning device 12 may be configured to define 121 the verification path.

For defining 121 the verification path, the commissioning device 12 may further be configured to send 1211 an appendage indication to the control device 11 responsive to a touch of a symbol in the user interface representing an appendage component of the plurality of components 21 for appending to the verification path, the appendage indication indicating the appendage component.

In other words, one component after the other of the plurality of components 21 of the lighting system 2 may be appended to the verification path in accordance with corresponding user inputs at the commissioning device 12.

The commissioning device 12 is further configured to display 122 the verification path in a digital floor plan.

The digital floor plan may be retrieved from the control device 11, and the verification path may be retrieved from or be defined in interaction with the control device 11.

The digital floor plan identifies and locates a respective component of a plurality of components 21 of the lighting system 2 (see FIG. 6). The verification path defines a verification sequence of the plurality of components 21 (see FIG. 7).

For displaying 112 the verification path, the commissioning device 12 may further be configured to indicate 1221 a position of the commissioning device 12 in the digital floorplan.

The commissioning device 12 is further configured to send 123 a start indication to the control device 11 responsive to a touch of a symbol in the user interface representing a start button of a manual operation mode.

Additionally, the commissioning device 12 may further be configured to send 123A a same start indication to the control device 11 as in step 123, responsive to a touch of a symbol in the user interface representing a start button of an automatic/animated operation mode.

The respective start indication will trigger the control device 11 to communicate 113 an actuation of a respective next component of the plurality of components 21 in accordance with the verification sequence.

The commissioning device 12 is further configured to receive 124 an actuation indication indicating a respective next component of the plurality of components 21 in accordance with the verification sequence from the control device 11.

The commissioning device 12 is further configured to highlight 125 a symbol in the user interface representing the respective next component.

In the manual operation mode, the commissioning device 12 is further configured to detect 126 a touch of a symbol in the user interface representing an actuated component of the plurality of components 21 as determined by the user.

In the automatic/animated operation mode, the commissioning device 12 may further be configured to detect 126A a lapse of a configurable timeout timer (e.g. 3 seconds per respective next component) following which the the respective next component represented by the highlighted symbol is taken as the actuated component. This operation mode may especially be beneficial in open spaces where the user may visually check a few components 21 from one location. Unless the user intervenes, the plurality of components 21 will one after another be actuated by the control device 11, highlighted as a symbol in the user interface and conclusively confirmed by the commissioning device 12, and verified by the control device 11. The user may passively let the progressing interaction between the control device 11 and the commissioning device 12 happen while the respective next components actuated in the building/space and highlighted in the user interface match, and only needs to intervene via the user interface upon a mismatch.

For a more comprehensive and user-friendly control of the progressing interaction, further symbols may be provided in the user interface of the commissioning device 12 being representative of symbols for pause/resume and/or rewind functionality, for example. Then the user may pause and/or rewind the interaction upon a mismatch, touch a symbol in the user interface representing the (actually) actuated component, and resume the interaction.

The interaction continues in the defined order until every component of the plurality of components 21 of the verification sequence has been verified.

The commissioning device 12 is further configured to send 127 an actuation confirmation indicating the actuated component to the control device 11. As noted previously, the actuated component may be indicated manually by the user or conclusively confirmed.

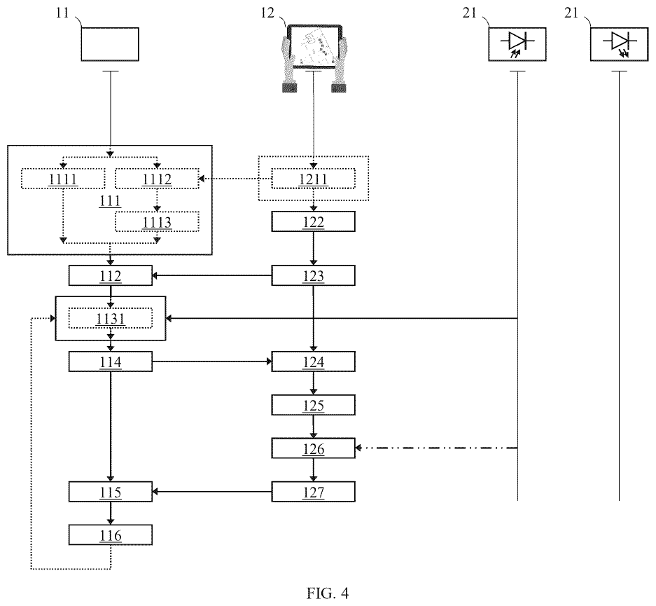

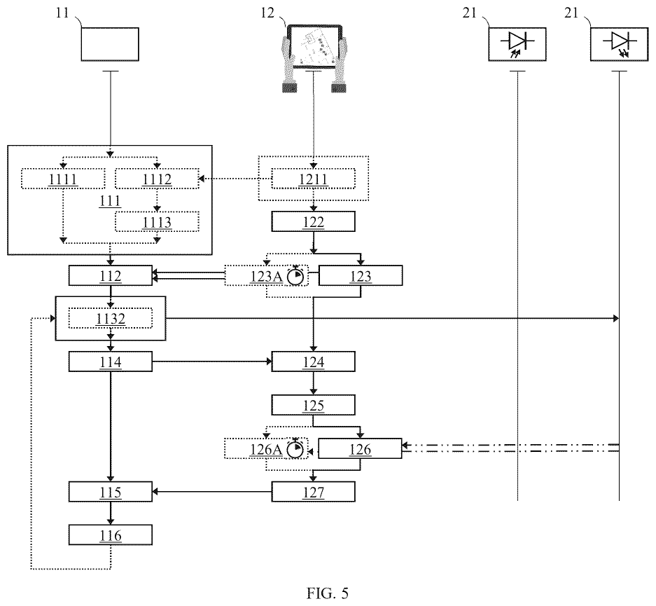

FIG. 4 illustrates the interlinked workflows of FIGS. 2 and 3 when verifying sensors or light switches of a commissioned lighting system 2, and FIG. 5 illustrates the interlinked workflows of FIGS. 2 and 3 when verifying luminaires of a commissioned lighting system 2.

As already mentioned, the communicating 113 of the actuation of the respective next component works differently depending on the component to be verified (respective next component).

As shown in FIG. 4, the verification sequence may indicate a particular sensor or light switch, or any other input component (respective next component) to be actuated by the user. The user may proceed to and actuate the respective next component, for example by moving around in a detection area of a motion sensor, by pointing a light source on a daylight sensor, by actuating the particular light switch, etc. The actuation of the respective next component may be detected 1131 by the control device 11. The commissioning device 11 then receives 124 the actuation indication indicating the respective next component, and highlights 125 the symbol in the user interface representing the respective next component. In other words, the respective next component is suggested to the user via the user interface of the commissioning device 12. The user may then touch a symbol in the user interface representing an (actually) actuated component of the plurality of components 21 as determined by the user, resulting in an actuation confirmation being sent 127 indicating the actuated component to the control device 11. The control device 11 may then verify 115 a match of the actuated component and the respective next component.

As shown in FIG. 5, the verification sequence may indicate a particular luminaire, or any other output component (respective next component) to be actuated by the control device 11. The control device 11 may actuate the particular luminaire, for example by initiating a continuous or flashing operation. The user may proceeded to and detect the actuation of the respective next component. The commissioning device 11 further receives 124 the actuation indication indicating the respective next component, and highlights 125 the symbol in the user interface representing the respective next component. In other words, the respective next component is suggested to the user via the user interface of the commissioning device 12. In the manual operation mode, the user may then touch a symbol in the user interface representing an (actually) actuated component of the plurality of components 21 as determined by the user, whereas in the automatic/animated operation mode explained in connection with FIG. 3 above, the respective next component represented by the highlighted symbol may conclusively be taken as the actuated component upon a lapse of the configurable timeout timer.

In both operation modes, an actuation confirmation is being sent 127 indicating the actuated component to the control device 11. The control device 11 may then verify 115 a match of the actuated component and the respective next component.

FIG. 6 illustrates a digital floor plan comprising a plurality of components 21 of a commissioned lighting system 2, and FIG. 7 illustrates an exemplary verification path in the digital floor plan of FIG. 6.

1. A control device (11) for verification of a commissioned lighting system (2),
the control device (11) being configured to
define (111) a verification path in a digital floor plan, the digital floor plan identifying and locating a respective component of a plurality of components (21) of the lighting system (2), and the verification path defining a verification sequence of the plurality of components (21);
receive (112) a start indication from a commissioning device (12);
communicate (113) an actuation of a respective next component of the plurality of components (21) in accordance with the verification sequence;
send (114) an actuation indication indicating the respective next component;
receive (115) an actuation confirmation indicating an actuated component of the plurality of components (21); and
verify (116) a match of the actuated component and the respective next component.

2. The control device (11) of claim 1, wherein for defining (111) the verification path, the control device (11) is further configured to
define (1111) the verification path in accordance with an algorithm of combinatorial optimization.

3. The control device (11) of claim 2, wherein the algorithm implementing a travelling salesperson problem.

4. The control device (11) of claim 1, wherein for defining (111) the verification path, the control device (11) is further configured to
receive (1112) an appendage indication from the commissioning device (12), the appendage indication indicating an appendage component of the plurality of components (21); and
append (1113) the appendage component to the verification path.

5. The control device (11) of claim 1, the respective next component comprising a sensor or light switch; and
the actuation comprising an actuation of the respective next component by a user;
wherein for communicating (113) the actuation, the control device (11) is further configured to
detect (1131) the actuation of the respective next component.

6. The control device (11) of claim 1,
the respective next component comprising a luminaire; and
the actuation comprising an actuation of the respective next component by the control device (11);
wherein for communicating (113) the actuation, the control device (11) is further configured to
perform (1132) the actuation of the respective next component.

7. The control device (11) of claim 1,
the respective next component comprising a group of components of the plurality of components (21).

8. The control device (11) of claim 1, wherein for verifying (116) the match, the control device (11) is further configured to
readdress (1161) the respective next component responsive to a mismatch of the actuated component and the respective next component.

9. A commissioning device (12) for verification of a commissioned lighting system (2),
the commissioning device (12) comprising a user interface, and being configured to:
display (122) a verification path in a digital floor plan, the digital floor plan identifying and locating a respective component of a plurality of components (21) of the lighting system (2), and the verification path defining a verification sequence of the plurality of components (21);
send (123) a start indication to a control device (11) for verification of the commissioned lighting system (2) responsive to a touch of a symbol in the user interface representing a start button;
receive (124) an actuation indication indicating a respective next component of the plurality of components (21) in accordance with the verification sequence from the control device (11);
highlight (125) a symbol in the user interface representing the respective next component;
detect (126) a touch of a symbol in the user interface representing an actuated component of the plurality of components (21) as determined by the user; and
send (127) an actuation confirmation indicating the actuated component to the control device (11).

10. The commissioning device (12) of claim 9, further being configured to
send (123A) a start indication to the control device (11) responsive to a touch of a symbol in the user interface representing a start button of an automatic operation mode; and
detect (126A), in the automatic operation mode, a lapse of a configurable timeout timer following which the the respective next component represented by the highlighted symbol is taken as the actuated component.

11. The commissioning device (12) of claim 9, further being configured to
define (121) the verification path.

12. The commissioning device (12) of claim 11, wherein for defining (121) the verification path, the commissioning device (12) is further configured to
send (1211) an appendage indication to the control device (11) responsive to a touch of a symbol in the user interface representing an appendage component of the plurality of components (21) for appending to the verification path, the appendage indication indicating the appendage component.

13. A system (1) for verification of a commissioned lighting system (2), comprising:
a control device (11) according to claim 1;
a commissioning device (12) comprising a user interface, and being configured to:
display (122) a verification path in a digital floor plan, the digital floor plan identifying and locating a respective component of a plurality of components (21) of the lighting system (2), and the verification path defining a verification sequence of the plurality of components (21);
send (123) a start indication to a control device (11) for verification of the commissioned lighting system (2) responsive to a touch of a symbol in the user interface representing a start button;
receive (124) an actuation indication indicating a respective next component of the plurality of components (21) in accordance with the verification sequence from the control device (11);
highlight (125) a symbol in the user interface representing the respective next component;
detect (126) a touch of a symbol in the user interface representing an actuated component of the plurality of components (21) as determined by the user; and
send (127) an actuation confirmation indicating the actuated component to the control device (11); and
communication means (13) for connecting the control device (11), the commissioning device (12) and a plurality of components (21) of the lighting system (2).

14. The system (1) of claim 13. the commissioning device (12) comprising the control device (11).
